(19) United States
(12) Patent Application Publication
(10) Pub. No.: US 2005/0156872 A1
(43) Pub. Date: Jul. 21, 2005

(54) System for providing an input signal, device for use in such a system and computer input device

(76) Inventor: Erwin Welbergen, Broekermaerdijk (NL)

Correspondence Address: DAVID A. GUERRA, 933 OLANDER WAY SOUTH, SUITE 3, SOUTH PASADENA, FL, 33707, US

(21) Appl. No.: 10/507,509

(22) PCT Filed: Feb. 26, 2003
(86) PCT No.: PCT/NL03/00145

(30) Foreign Application Priority Data
Mar. 13, 2002 (NL) 1020616

(51) Int. Cl. G09G 5/00

(52) U.S. Cl. 345/156

(57) ABSTRACT

A system for providing an input signal, comprises an element (M,1) controllable by a user by means of interaction with a user's limb, which system comprises a sensor (5,6) capable of detecting the presence of a limb placed over at least part of the element (M,1), timing means (2) for determining the length of a time during which the limb is present and means (11,9,7,8) of generating an alarm signal if the length of time exceeds a threshold value. The alarm signal can be used to effect discontinuation of the presence of the limb.

The invention relates to a system for providing an input signal, comprising an element controllable by a user by means of interaction with a user's limb. The invention also relates to a device for use in such a system. The invention further relates to a computer input device, e.g. a mouse.

Examples of such a system, device and input device are known.

A problem associated with prolonged use of such a system, particularly well known in the context of computer mice, is the risk a user runs of developing repetitive strain injury (RSI). The condition arises when one or more muscles controlling a limb, e.g. a hand or wrist, are continuously strained over a relatively long period of time. In particular when the limb is held immobile during longer periods of time, the condition most commonly known as RSI may arise, causing pain and loss of function, temporary and/or chronic, and this will often make it impossible for the user to continue using the system.

The invention aims to provide a system for providing an input signal and a computer input device according to the type mentioned above that can be used by people with reduced risk of contracting repetitive strain injury.

This aim is achieved by providing a system for providing an input signal, comprising an element controllable by a user by means of interaction with a user's limb, which system comprises a sensor capable of detecting the presence of a limb placed on or over at least part of the element, timing means for determining the length of time during which the limb is present and means for generating an alarm signal if said length of time exceeds a threshold value.

The invention is based on the insight that the use of a system for providing an input signal—such as a computer mouse—is often characterised by frequent and prolonged inactive periods. More often than not, the user will rest his hand, or whichever part of the body is used to interact with the system, on or just above the element used to control it. Such a situation can arise, for example, when a user rests his hand on a computer mouse or trackball whilst viewing web pages. During that time the muscles remain tightened. A cramped position is thus maintained, which is potentially even more damaging than a long period of sustained interaction. Existing systems that monitor the period of interaction cannot be used to prevent this. The system according to the invention thus has the advantage that a user can be alerted to the fact that he is maintaining the same cramped, potentially damaging posture.

Preferably, the system comprises means of providing a tactile signal to the limb placed over the element, in response to the alarm signal.

This feature is useful for instilling a conditioned reflex in the user. The conditioned reflex will arise naturally after the user has experienced the tactile signal and removed his hand or other part of the body from its position of rest on or over the user-controllable element a few times. Once he has acquired the conditioned reflex, the user can be alerted without being interrupted in his activities. By eliminating the time the limb is in the presence of the user-controllable element while the system is not actually used, the total time of muscle strain is reduced without reducing productive time.

Preferably, the system is capable of determining whether interaction takes place between the user-controllable element and the user's limb, wherein the system only generates the alarm signal if no substantial interaction takes place during the determined time interval.

Thus, normal use of the system is not interrupted.

According to an aspect of the invention, a device for use in a system according to the invention is provided, comprising means for detecting the presence of a user's limb, wherein the configuration of the device is adapted to allow the means for detecting the presence of a user's limb to detect the presence of a user's limb placed on or over at least part of the element, which device further comprises means for generating a signal representative of the detected presence, and means for communicating the signal representative of the detected presence to the timing means.

In this context, the term configuration is understood to mean the physical configuration of the device, i.e. its shape and the location of its various components. It is adapted to allow the means for detecting the presence of a user's limb to detect the presence of a user's limb placed on or over at least part of the element in the sense that its shape and the location of the detecting means are adapted to the particular type of limb, i.e. wrist, foot, used to control the element and the type and shape of the user-controllable element. Thus, for a system wherein a computer mouse is the user-controllable element, the device may be a mouse mat, whereas if a pedal is the user-controllable element, it may be a mat for a foot well, for instance.

According to another aspect of the invention, there is provided a system for providing an input signal, comprising an element controllable by a user by means of interaction with a user's limb, which system comprises means for detecting activity of the user's limb and means for generating an alarm signal if no user activity is detected after a period of user activity.

This system has the advantage of allowing detection of continued cramped, motionless positions, which are particularly damaging. It is noted that the system does not require a sensor to detect the presence of a limb, although a sensor could be used. Activity detection may, for example, be accomplished by analysis of the input signal provided by means of the user-controllable element.

According to another aspect of the invention, there is provided a device for use in the last-mentioned system according to the invention, comprising means for detecting activity of the user's limb, wherein the configuration of the device is adapted to allow the means for detecting activity of the user's limb to detect the activity of a user's limb placed on or over at least part of the element, which device further comprises means for generating a signal representative of the detected activity, and means for communicating the signal representative of the detected activity to a controller configured to generate an alarm signal if no user activity is detected after a period of user activity.

In this context, as before, the term configuration is understood to mean the physical configuration of the device, i.e. its shape and the location of its various components. It is adapted to allow the means for detecting activity of a user's limb to detect the activity of a user's limb placed on or over at least part of the element in the sense that its shape and the location of the detecting means are adapted to the particular type of limb, i.e. wrist, foot, used to control the element and the type and shape of the user-controllable element. Thus, for a system wherein a computer mouse is the user-controllable element, the device may be a mouse mat or a wrist-band with a motion sensor, whereas if a pedal is the user-controllable element, it may be a mat for a foot well, for instance, or an ankle-band with a motion sensor.

According to another aspect of the invention, a computer input device, e.g. a mouse, is provided, comprising a sensor capable of detecting the presence of a user's hand placed over at least part of the device, timing means for determining the length of a time interval during which the presence of the limb is continuously detected and means of generating an alarm signal if the time interval exceeds a threshold value.

According to a last aspect of the invention, a computer input device, e.g. a mouse, is provided, comprising means for detecting user activity means for generating an alarm signal if no user activity is detected after a period of user activity.

These are particularly advantageous implementations of the invention, since users of computer mice are at particular risk of contracting repetitive strain injury. Of course, in the context of the present invention the term computer mouse can be considered indicative of a whole class of computer input devices, such as trackballs, joysticks, etc.

The invention will now be explained in further detail with reference to the drawing, schematically showing a cross-sectional view of a computer mouse for use in a system according to the invention.

Although some equipment in which user-commands are processed is voice-activated, in most cases a device is employed that relies on mechanical interaction. Cars are controlled by pedals moveable by the user's foot, television sets employ mechanical switches, and computers use peripheral devices such as a keyboard, joystick, game pad or mouse. Even where no substantial force is applied by the user, motion of one or more parts of the body is translated into a control signal. Thus, a prolonged period of use of such equipment is characterised by extended periods of muscle tension. It is well known that longer periods of muscle tension can lead to repetitive strain injury (RSI).

RSI is a particularly well known problem in the field of computing, since this field is characterised by the continuous provision of input signals by the user. However, the problem is prevalent in other technical areas as well. The invention provides a system that is useful for reducing the chances of contracting RSI and for reducing the symptoms once a person has become afflicted by RSI. Because RSI is of great concern to computer users, this description will focus on examples of implementations in the field of computing. However, the invention is quite generally applicable in all fields where a user interacts with an input device by moving parts of the body.

Of the approaches used hitherto to prevent repetitive strain injury (RSI), two stand out particularly. Firstly, a great deal of effort has been expended on providing input devices with an ergonomic design. Some designs focus on adapting the part of the device that comes into direct contact with a body part to the shape of that body part. Other designs allow the user to change the posture of that body part whilst retaining control. However, ergonomic designs rely on proper use. Over prolonged periods of time, damage can still occur. People resting a limb on the device in between issuing commands can do so in a cramped position.

A second approach to the prevention of RSI is common in office environments. This approach uses software that monitors a user's activity during longer periods of time and signals the user to take breaks if the total time worked exceeds pre-set criteria. This approach fails to recognise that a user will often rest his hand on the mouse, keyboard or touchpad whilst viewing the screen or doing something else. The muscles of the wrist and forearm will then also be tensed: the position is just as cramped as when the input device is being used. Because no input signals are provided during this period, traditional monitoring software will not alert the user.

The invention provides a system for providing an input signal to, for example a computer. The system comprises an element controllable by a user by means of interaction with a user's limb. The term limb is used quite generally to refer to any moveable part of the body, such as a finger, hand, arm, foot, etc. The element is a physical device or part of such a device that is able to detect that movement.

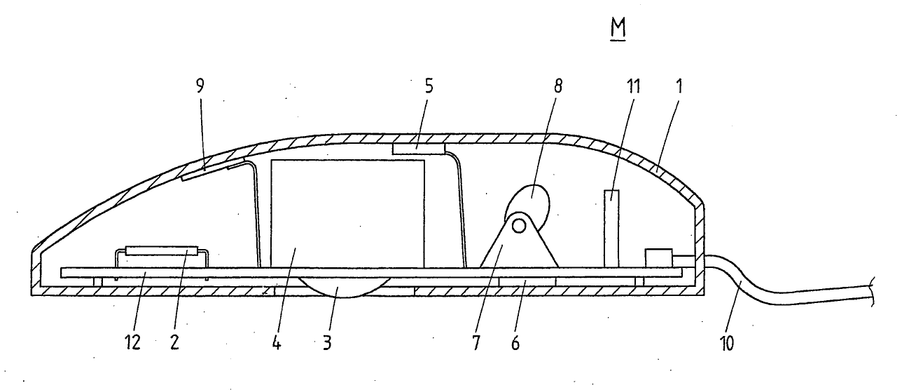

The element can, for example, be a pedal, interacting with a user's foot. It can be a joystick, interacting with a user's hand, or it can be a touchpad, interacting with a user's finger. In the example shown, the element is a mouse M, interacting with a user's hand, to provide an input signal to a computer (not shown). The mouse M is controlled through direct contact between the user's limb, the hand, and a housing 1. The mouse M of FIG. 1 is a mechanical mouse. A ball 3 is rotated by movement of the mouse M across a surface. An encoder arrangement 4, optical or mechanical, encodes the movement into pulses that are converted by an on-board processor chip 2 into a data signal for transmission to a computer through the connector cable.

Features of the system according to the invention can be implemented in only the mouse M, or in a combination of the mouse M and software running on the computer. This software can come in the shape of a mouse driver, compiled in the operating system or linked to the operating system. It can alternatively come as a user application, as will be understood by the skilled person.

The system comprises a sensor capable of detecting the presence of a limb placed over at least part of the element. That is, the system is able to detect the presence of a body part in close proximity to the element controlled by the body part.

In the mouse M, one example of such a sensor is a pressure sensor 6, located underneath the mouse M. In this case the user must actually be touching the housing 1 for the system to be able to sense the presence of it.

As an alternative, or in addition to the pressure sensor 6, there is provided a sensor 5 in the vicinity of the cover of the housing 1. This sensor 5 can be of one of a number of different types. Again, the sensor 5 can be a pressure sensor, which provides a signal when the weight of the user's hand induces a pressure in the housing 1. Alternatively, the sensor can be of an optical or capacitive type, able to sense the presence of a hand hovering over the mouse M as well as of a hand actually in mechanical contact with the housing 1 of the mouse M. This is an advantage, particularly if the mouse M is small compared to the user's hand. A hand enveloping, but not touching, the mouse M could still be in a strained, potentially damaging position, and would be detected by a system comprising such a sensor.

In another embodiment, the sensor may be comprised in a separate device, provided as part of the system. For example, the sensor may be comprised in a mouse mat (not shown), which is provided together with the mouse M. The location of the sensor is such, that the presence of the user's wrist is detected when the user is holding the mouse M. As before, the sensor in such an embodiment may be an optical sensor, a pressure sensor, or a capacitive sensor. The device (e.g. a mouse mat) in this embodiment of the invention further comprises an interface for providing an output signal to a controller (e.g. the computer receiving the input signal from the mouse M). The output signal is the output signal of the sensor, or a conversion thereof to a certain protocol for computer peripherals. This embodiment has the advantage of functioning with conventional input devices (i.e. computer mice).

In embodiments for use with other user-controllable input devices, other type of devices with sensors may be used. For example, where a brake pedal is the user-controllable element, there may be provided a device to be electrically attached to the brake light.

The system makes use of timing means to determine the length of time in which the position is maintained. In the mouse M shown, these timing means can be provided as a simple analogue electronic circuit, comprising a capacitor which is charged from the moment one or both of the sensors 5, 6 detects the presence of a hand, and short-circuited when the hand is removed. In an alternative embodiment, a clock provided to control the on-board processor 2 is used. The computer's system clock could also be used, in which case the timing means will comprise software, for example a routine in the mouse driver software.

When the time interval during which the presence of the user's limb is continuously detected exceeds a threshold value, an alarm signal is issued. Monitoring software that monitors a user's input system usually uses a large and disturbing window to force the user to take a break. This interrupts the user's chain of thought and concentration on the task he is carrying out. Responding to such a disruptive signal is annoying the user. Many users choose to hit the ignore button to make the window disappear. When work has to be finished under pressure, many users disable the monitoring software altogether. Complying to the instructions of the software reduces the time available for productive work, either for short periods or longer periods of time.

The invention makes use of a non-disruptive signal in order to train the user to acquire a conditioned reflex. After some time has been spent getting used to the system, reaction to the alarm signal should occur automatically in a thoughtless fashion. Therefore, the system of the invention does not reduce the productive time. At least three types of alarm signal could in principle be used within the scope of the invention to achieve such a conditioned reflex.

Firstly, a visual signal could be used. A visual alarm signal is issued that does not disturb the user too much. For instance, the mouse could be provided with a Light Emitting Diode (LED). Alternatively, a small icon or window could pop up on the computer screen, for example at its edge.

Secondly, in an advantageous embodiment, the system is capable of providing a tactile signal in response to the alarm signal, preferably to the limb placed over the element. Many means of providing a tactile signal are known. The exact implementation will, of course, to a large extent depend on the particular way in which a user interacts with the system. For example, a foot pedal could be provided with a servo-drive or a hydraulic or pneumatic piston, to lightly shake or jog the pedal.

The mouse M used here as an illustrative example is provided with an eccentric mass 8 that can rotate about an axis 7. Rotation of the mass 8 will cause the housing 1 of the mouse M to vibrate. As an alternative, an actuator 9 can be used, either to cause the top of the housing 1 to vibrate, or to provide a pulse signal. Examples of actuators include magnetic actuators and mechanical actuators driven by a linear or rotating motor. Another alternative would be to provide a motor that drives the ball 3 so as to move the housing 1 of the mouse M. All of these techniques are well known in the context of computer peripherals. However, up till now, they have been used to provide force feedback to players of computer games. In other words, the tactile signals have been provided in response to input signals, rather than in response to the absence of user input.

Although in the example shown the means for providing the tactile signal is part of the mouse M, the means for providing the tactile signal can be a separate element. This element can be a type of bracelet, a mouse pad or even be incorporated in a keyboard.

This aspect of the invention makes good use of the fact that a tactile signal is particularly useful for instilling a conditioned reflex in a user. The tactile signal is the least interrupting type of signal. After a short learning curve, a conditioned reflex will take place, where the tactile signal will result in a quasi non-voluntary movement of the hand from the mouse. After a while, the user will not even be aware of the fact that an alarm signal has been issued and that he has removed his hand in response.

A third type of alarm signal is a warning sound. In this variant, the system is capable of generating an audible alarm signal or an alarm signal suitable for triggering the generation of an audible signal. For example, in a variant that is fully contained in the mouse M, the mouse comprises a speaker 11 or some other means of generating an acoustic signal. In an alternative implementation, the mouse M issues an appropriate signal, generated by the on-board processor 2 for instance, to the computer to which it is attached. This signal then triggers the generation of an audible signal by the computer.

Since reading and watching a screen is a mainly visual task, the audible signal still has the advantage over a visual signal that it is less disruptive to the user. The two are parallel information systems, which to some extent can operate independently.

In a preferred embodiment, another property of the audible signal is put to use. In this embodiment, the nature of the signal changes if the presence of the limb continues to be detected after the alarm signal has initially been generated. Thus, user's who initially ignore the alarm signal can, at some point, be forcefully reminded that it is time to take action.

For example, the audible signal can be generated after an icon has been on the screen for some time without any action having been taken, or after the ex-centric mass 8 has rotated for some time. The use of an audible signal in this respect has the advantage that the user's environment is alerted. Social pressure may very well cause a user to change his habits.

Of course, the nature of the alarm signal could change in other ways as well, for example by becoming more intense. In some known tactile devices for instance, the distance of the ex-centric mass 8 to the axis 7 is variable to make the vibrating sensation more intense.

Preferably, the system is capable of determining whether interaction takes place between the user-controllable element—joystick, pedal, mouse housing 1—and the user's limb. The system then only generates the alarm signal if no substantial interaction takes place during the determined time interval. A particularly easy way to implement this feature is by coupling the input signal generating means to the timing means such that the timer is only started when no input signal is being generated and is reset every time an input signal is generated.

This embodiment has the advantage that the alarm signal is only issued if the user's hand stays motionless for a prolonged period of time, since it is particularly this type of use that is most damaging. When input is being provided, the user's muscles tense and relax in turn, which is less damaging. Additionally, many input devices have an ergonomic design that is capable of preventing serious damage, so long as the device is actually being used in the intended way to provide input signals.

Of course, a user might develop an unintended conditioned reflex in this embodiment. He might just slightly jog the mouse M every time an alarm is issued, instead of removing his hand altogether. This problem will not occur in the preferred embodiment of the invention, wherein the system is capable of recording the interaction between the user's limb and the user-controllable element over a period of time. Thus, it is possible to ignore fleeting interactions or an input signal caused by a slight trembling.

Recording the interaction also enables the system to determine the nature of interaction and to compare the determined nature with one or more risk-profiles. Thus an alarm signal can be generated if the nature of the interaction conforms to a risk profile. For example, this feature can be used to discern whether a user is only using a scroll button (not shown in FIG. 1) on the mouse, but otherwise resting his hand on the mouse M.

Preferably, the system is capable of compiling and storing a record of the interaction between the user-controllable element and the user's limb over a period of time. Alternatively, it could just record every instance in which an alarm signal is generated. Thus a complete record of user behaviour can be compiled. Company health officers can use such a record to identify individuals who are at risk of developing RSI. They can be offered appropriate training, for instance. The feature can also be used to ward of an employer's liability, by demonstrating that an employee's habits have caused the development of RSI.

It will be understood that the invention is not limited to the above-described embodiments, which can be varied in a number of ways within the scope of the invention. For instance, the mouse could just as well be an optical mouse. Data can be exchanged with the computer through a wireless connection instead of through a cable and connector.

In an alternative embodiment the system can be made without the sensor capable of detecting the presence of a limb. In one variant, the software part of the system monitors user activity and if no activity is detected after a predetermined period of continuous activity a tactile signal is generated alerting the user to withdraw his hand. This embodiment can be combined with all other features of the system described above.

A system without the sensor capable of detecting the presence of a limb has the advantage that other types of sensor can be used. The software monitor just discussed in the context of computer mice is a good example. Another example would be a device comprising a motion sensor, e.g. a wrist-wearable device in the case of an input device controlled by hand. In another setting, the device my comprise some sort of image analyser for detecting activity of the user's limb.

Each of the variants described herein thus relies on the insight that maintaining a sustained cramped motionless position poses a great threat to the development of Repetitive Strain Injury. The systems and devices described allow such positions to be detected, thus providing a useful aid in the prevention of RSI.

1. System for providing an input signal, comprising an element (M,1) controllable by a user by means of interaction with a user's limb, which system comprises a sensor (5,6) capable of detecting the presence of a limb placed on or over at least part of the element (M,1), timing means (2) for determining the length of time during which the limb is present and means (11,9,7,8) for generating an alarm signal if said length of time exceeds a threshold value.

2. System according to claim 1, comprising means (7,8,9) of providing a tactile signal in response to the alarm signal, preferably to the limb placed over the element.

3. System according to claim 1 or 2, wherein the nature of the alarm signal changes if the presence of the limb continues to be detected after the alarm signal has initially been generated.

4. System according to any one of the preceding claims, comprising means (2,11) of generating an audible alarm signal or an alarm signal suitable for triggering the generation of an audible signal.

5. System according to any one of the preceding claims, capable of determining whether interaction takes place between the user-controllable element and the user's limb, wherein the system only generates the alarm signal if no substantial interaction takes place during the determined time interval.

6. System according to any one of the preceding claims, capable of recording the interaction occurring over a period of time.

7. System according to claim 6, capable of determining the nature of interaction and of comparing the determined nature with at least one risk-profile, wherein the system generates the alarm signal if the nature of the interaction conforms to the risk profile.

8. System according to any one of the preceding claims, capable of compiling and storing a record of the interaction between the user-controllable element and the user's limb and/or of the generation of alarm signals over a period of time.

9. System according to any one of the preceding claims, wherein the sensor is comprised in the element.

10. Device for use in a system according to any one of claims 1-8, comprising means for detecting the presence of a user's limb, wherein the configuration of the device is adapted to allow the means for detecting the presence of a user's limb to detect the presence of a user's limb placed on or over at least part of the element, which device further comprises means for generating a signal representative of the detected presence, and means for communicating the signal representative of the detected presence to the timing means.

11. System for providing an input signal, comprising an element (M,1) controllable by a user by means of interaction with a user's limb, which system comprises means for detecting activity of the user's limb and means for generating an alarm signal if no user activity is detected after a period of user activity.

12. System according to claim 11, wherein the element comprises means for detecting user activity.

13. Device for use in a system according to claim 11, comprising means for detecting activity of the user's limb, wherein the configuration of the device is adapted to allow the means for detecting activity of the user's limb to detect the activity of a user's limb placed on or over at least part of the element, which device further comprises means for generating a signal representative of the detected activity, and means for communicating the signal representative of the detected activity to a controller configured to generate an alarm signal if no user activity is detected after a period of user activity.

14. Computer input device (M), e.g. a mouse, comprising a sensor (5,6) capable of detecting the presence of a user's hand placed over at least part of the device (M), timing means (2) for determining the length of a time interval during which the presence of the limb is continuously detected and means (7,8,9,11) of generating an alarm signal if the time interval exceeds a threshold value.

15. Computer input device (M), e.g. a mouse, comprising means for detecting user activity means for generating an alarm signal if no user activity is detected after a period of user activity.
